(19) United States
(12) Patent Application Publication
(10) Pub. No.: US 2015/0213353 A1
(43) Pub. Date: Jul. 30, 2015

(54) SMART BUSINESS CARD

(71) Applicant: Antonio Cuervo, Mississauga (CA)

(72) Inventor: Antonio Cuervo, Mississauga (CA)

(21) Appl. No.: 14/163,644

(22) Filed: Jan. 24, 2014

(51) Int. Cl. G06K 19/077

(52) U.S. Cl. CPC G06K 19/07703; G06K 19/07749

(57) ABSTRACT

The present invention is a smart business card with touchscreen surface for transmitting information stored in a memory card or in the internet and displaying the information on screen by using touchscreen technology all disposed within a business card sized housing.

### FIELD OF THE INVENTION

The present invention relates to a smart business card with touch screen surface and more particularly, to a touch screen business card with touch-sensitive surface for transmitting information stored in a memory and displaying the information on screen by using touch screen technology all disposed within a business card sized housing.

### BACKGROUND OF THE INVENTION

Business cards are used throughout the world and accepted to represent a company, it's representatives or agents during initial client or customer contacts, at society and trade organization meetings, at conventions and at social events. The traditional paper business cards are usually imprinted with an individual or unit name, title, address, telephone, fax and other basic information of the business card owner.

In many occasions, business card are provided together with brochures, audiotapes, videotapes, talking cards having a voice chip and various electronic message devices. Such additional information are provided to advertise a company's product(s), vacation destination, real estate properties and the like. They are used to provide detailed information about, their advantages, usage, history, accomplishments, value, accommodations or house locations. Such information allows the a potential client/customer to listen to and/or see the desired information needed to make an intelligent and informed choice and/or decision for the product or service.

There remains a need for a new business card that provides more information than conventional business card, to attract people's interest in the exchanges and to provide more information than just the person's name and contact information.

The prior art provides a number of business card devices and system having various designs, structures, configurations and materials. U.S. Pat. No. 7,931,202 discloses a business card for capturing and reproducing sound. More particularly the invention is directed to a business card that permits the provider to pre-record sound information for the user and permits the user to playback the pre-recorded sound information. U.S. patent No. 2009/0109701 discloses an illuminated business card including a light guiding card body to illuminate the business card when being used in the dark circumstances. U.S. Pat. No. 6,254,001 entitled “electronic business card device” discloses a method of transferring business card information from a first user to a second user providing an electronic business card device storing data similar to the stored on the business card and selectively transfer the stored business card data for storage and selective retrieval. CN. Patent No. 202862868 discloses an LED business card using a flexible paper battery. The business card comprises of a battery, a switch and an LED. This combination makes the card shine in order to attract people's interest. WO. Patent No. 2001022347 entitled “Convertible business card with game” discloses a business card that can convert to a game, or CN. Patent No. 202556975 entitled “business card with scale” to be used for length measurement and line drawings. The methods disclosed above are made to add function and practical value to the business card and increase the benefits of frequent use of the business card and to prevent from putting them aside and keeping the original card function.

A need exists for a smart business card that achieves all of the objectives of conventional business card and to provide related advertising and all information related to the business by using touch screen.

### SUMMARY OF THE INVENTION

The present invention is a smart business card for displaying stored information thereon by using touch technology on touch-sensitive surface. According to the present invention a smart business card that is approximately the size of a normal business card includes an upper layer with touch sensitive screen means, a thin glass with a thin-film conductive coating on top of the glass, a power source, and means for delivering power. The power source is a very thin rechargeable or any other kind of power source sandwiched between the upper layer and lower layer or located on the side of the screen. The touch sensitive screen allows for displaying information stored in the memory on the screen by using touch technology

It is the first object of the present invention to provide a smart business card that displays information related to the business card owner as well as other information that the owner would like to relate to the holder of the business card. There is only a very limited space on a 2″×3.5″ card to fit information.

It is another object of the present invention to provide a smart business card using the touch screen technology.

It is a further object of the present invention to provide a smart business card that serves the purpose of a business card while leaving a positive visual and mental impression on the recipient. To have access to all information by simple touch encourages the user to use the card more often and not throw it next to hundreds of other cards.

It is a further object of the present invention to be environmentally friendly. By putting all individual and company information in a digital format, use of paper cards, brochures, catalogues, and other promo material can be eliminated.

It is a further object of the present invention to allow the user to adjust the size, brightness, and other formats of the displayed information to sout to his or her likeness. For instance, many business cards have such a small size fonts that many users cannot see them well.

Other objects, features, and advantages of the present invention will be readily appreciated from the following description. The description makes reference to the accompanying drawings, which are provided for illustration of the preferred embodiment. However, such embodiment does not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 (a) shows a front elevation view of a smart business card with touch screen surface with an exemplary embodiment of the present invention;

FIG. 1 (b) shows a rear elevation view of the smart business card and FIG. 1 (c) shows a top plan view of the smart business card;

FIG. 2 (a-c) shows typical information which can be displayed on a smart business card;

FIG. 3 illustrates different elements of the smart business card;

FIG. 4 shows a schematic diagram of the functionality of a smart business card;

FIG. 5 shows a schematic diagram for connections of smart business cards to a computer or the internet;

FIG. 6 shows a schematic diagram of operation of related platform for the smart business card; and

FIG. 7 shows a schematic diagram of operation of related platform for the smart business card in another embodiment.

### DETAILED DESCRIPTION OF THE DRAWINGS

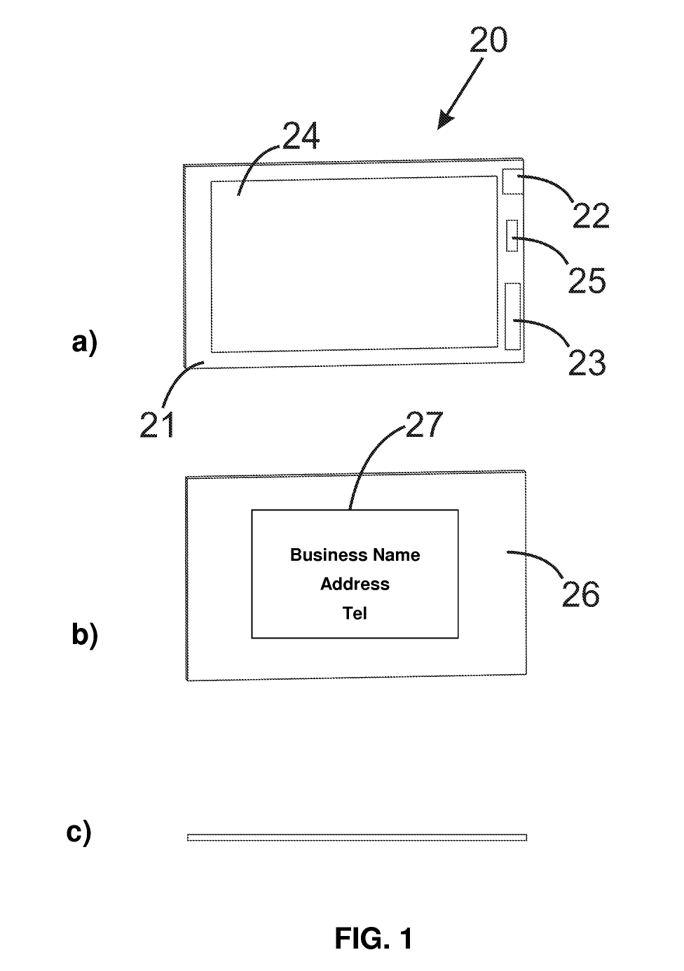

With reference to the drawings and to FIG. 1(a) in particular a smart business card device 20 in accordance with an exemplary embodiment of the present invention is illustrated. The touch screen surface 21 is made of a thin glass. Touch screen typically consists of a thin glass with a thin film conductive coating on top of the glass. The conductive layer is substantially transparent conductor such as indium oxide, zinc oxide, or other conductive polymers. Which are examples of substances generally referred to as transparent conductive oxides (TCOS). A touch sensitive display includes a touch area, circuit and a display device viewable through the touch area. The touch area includes a substantially transparent conductive polymer acting as a primary signal carrier for making a capacitive coupling to an object at a touch location. The circuit connects the conductive polymer of the touch area to a power source, where the circuit is configured to determine the touch location.

FIG. 1(b) is a rear elevation of the smart business card on which the information that is provided on conventional business cards is printed. The rear screen 26 can be made of printable plastic, metal or even glass. The rear screen can also be made of thin LED or OLED screens used in electronic products which increase the attractiveness of the displayed information on the product. The rear screen 26 can also be made of the same screen as the front screen 21 and demonstrates the necessary information on the back of the business card. Accordingly, the smart business card comprises of two screens in front and back with supported electronics inside and between the two screens.

Again referring to FIG. 1(b), at rear of the smart business card, the information such as logo, company name and address may be printed permanently. Such information can be printed or carved in steel or glass, or printed permanently on any type of material used at the back side of the smart business card to make it specific and unique for the card owner. With the reference to FIG. 1(b) the printed matter 27 may include a name, address, logo, or phone number of the company or individual whose identification information is stored in the memory.

Referring to FIG. 1(a-c) the touch screen 21 has the capability to display any type of information of interest to the card holder, such as images, text and so on. The display can be used to share business or advertising information related to new products, services and promotions.

With reference to FIG. 1(a), the device includes a memory card 22 to store the information. Memory may be a flash memory to run various software programs and sets of instructions stored in memory card 22 to perform various functions for the device and process data.

Again referring to FIG. 1(a), the information stored on a smart business card can be permanent which nobody can change the content of a smart business card by uploading different kind of information. By having an internal memory which is installed in a circuit board of the smart business card, the content of the smart business card become permanent.

Referring to FIG. 1(a), the power supply 24 is built in a housing between the upper surface and the lower surface of the touch screen display and is used for supplying power to the electrical components of the display device 21. The battery 24 is preferably an ultra-thin printed battery and can be of single use or rechargeable type. Alternatively, the battery 24 can comprise one or more solar cells or the like.

With the reference to FIG. 1(a) again the device includes a processor 23 preferably in the form of a microcontroller, microprocessor or other suitable device that interfaces between the memory and display so that during use, various operations of the device 20, including data display, can be controlled by the processor 23.

Referring to FIG. 1. Power button 25 is intended to turn on the display 20 from the moment that the button is touched and the processor 23 is connected to the battery 24 and is receiving power.

Referring to FIG. 1(c) the exemplary dimensions of the smart business card are provided here as follows: The length of the card as measured across the front is preferably about 3.5 inches, likewise the width as measured between the sides preferably about 2.0 inches and the thickness of the card is preferably about 0.12 inches. The thickness of the smart business card is limited by the thickness of the touchscreens display technology. Currently, the thickness of 0.12 inches is commercially achievable by transparent and flexible touchscreen displays. Although, it may be desirable with certain companies or persons to preserve the business card size, any size can be used for the present smart business card. Although the device is preferably of rectangular configuration, it will be understood that the shape may be circular, square, triangular or multisided shape.

Again referring to FIG. 1(a-c), different kinds of touch sensors serving as user interfaces in devices, such as mobile devices, are known in the art for sensing an input action of user. Touch sensors are usually placed on the top of an LCD, large parts of the sensor have to be made transparent, which can be achieved by manufacturing the touch sensor of transparent capacitive components. As is known in the art, an electrode element can be coated underneath the cover layer and is preferred as a transparent conductor forms a part of capacitor.

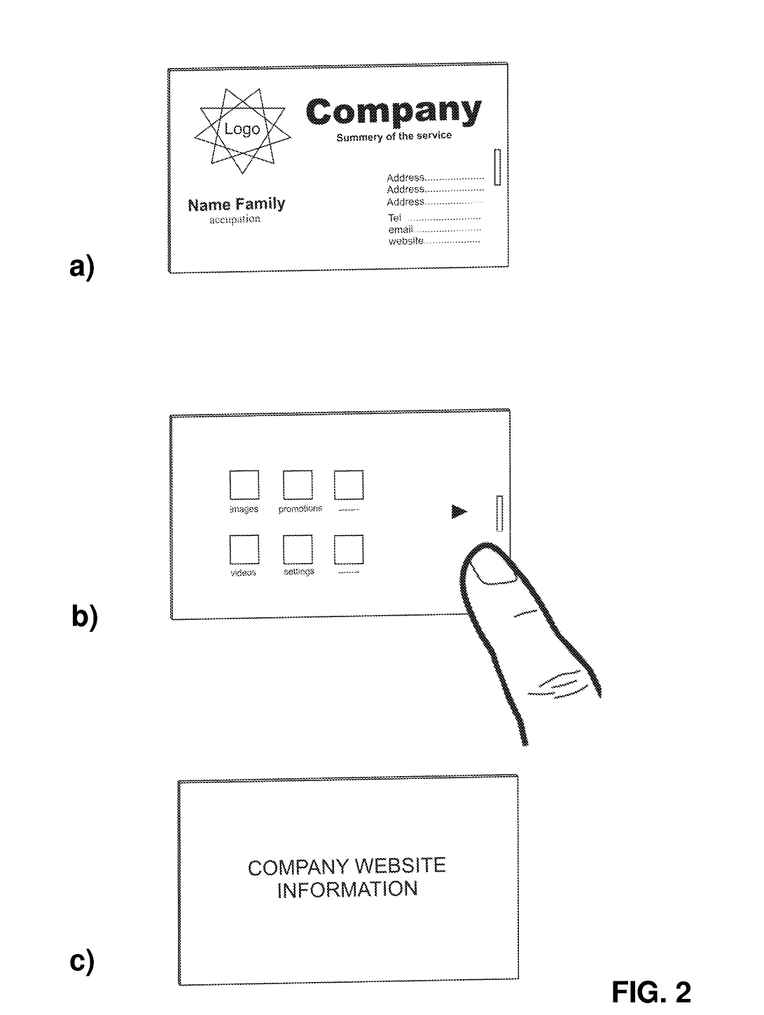

FIG. 2(a-c) illustrates another embodiment of the same device, wherein the functional keys are reduced to only one key. The information or data stored within the memory includes multiple pages of information. In order to allow a user to select subsequent pages of information, screen includes icons enabling the user to replace the information pages. The user can select the information pages by selecting pages from the menu by touching on screen. Information can be programmed. Once touched, the selected menu initiates a processor-generated command to replace the current page of information with the next page.

Again referring to FIG. 2(a-c), there is a touchscreen keyboard that helps user to inter the name, address and some specific code or numbers into the smart business card. The keyboard is the same as the keyboard in the smart phones and has all letters, numbers and characters.

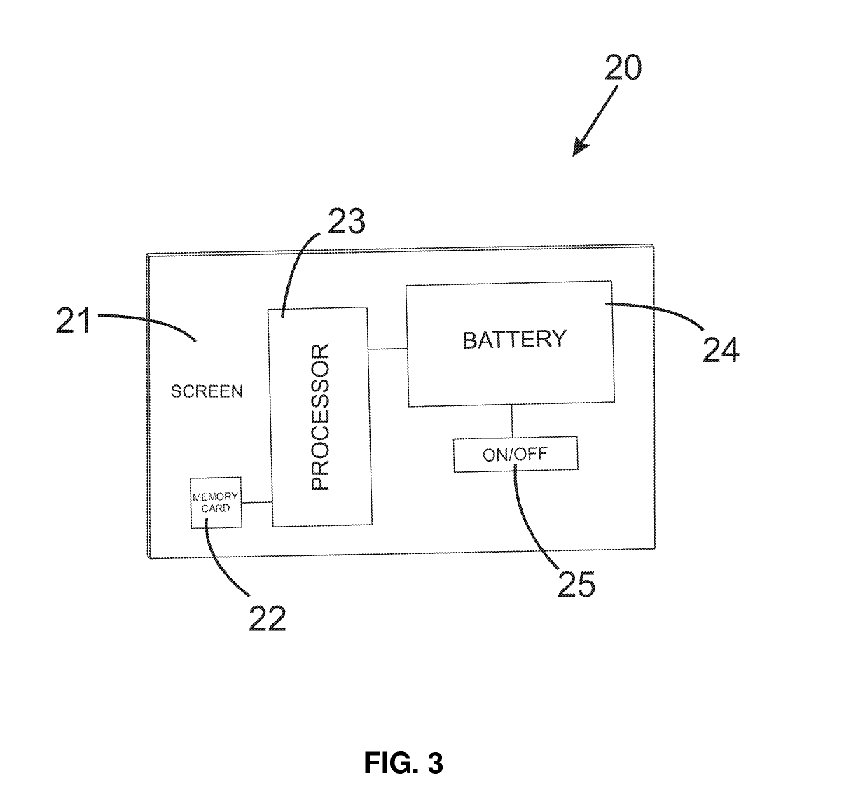

With reference to FIG. 3, the display screen 21 is operably connected to the memory 22 and processor 23. The data stored in memory 22 can display the information on single page, such as the name of an individual, company name and telephone number. The information stored within the memory is transmitted to the screen 21 where it is displayed for viewing by the user.

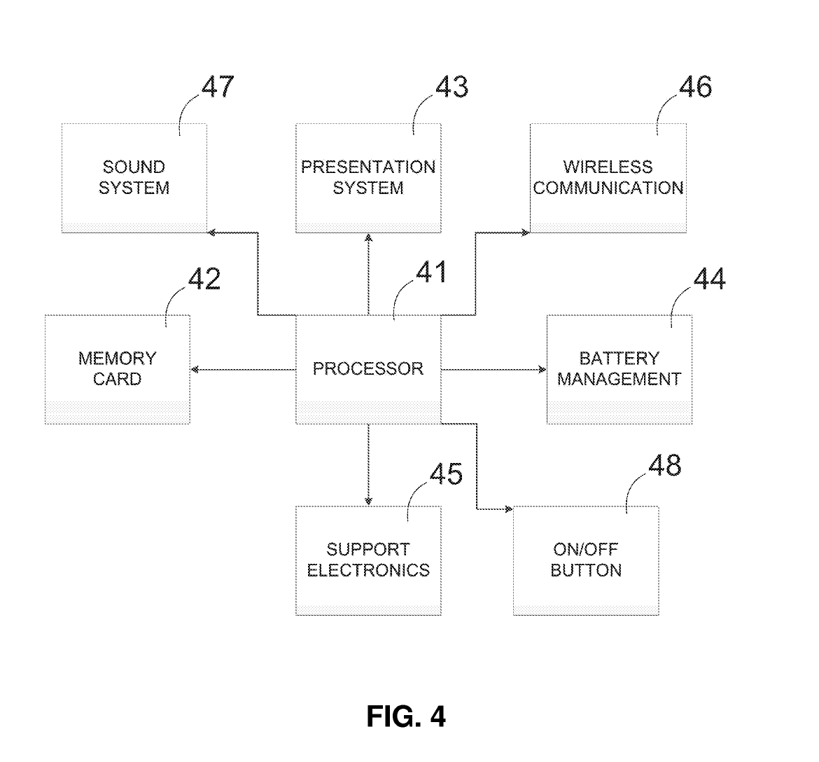

FIG. 4 shows the schematic diagram of the present invention. A smart business card comprises of a processor 41 to manage and process of functionality of said smart business card, a memory card to save the data which is presented in said business card, a presentation system 43 to display some information on a touchscreen device, a battery management unit 44 to supply power for operation of said smart business card, a support electronics unit 45 to connect all electronics equipment such as said processor, said memory, said battery together, the support electronics is an electric circuit board to provide functionality of said equipment together, a means for wireless communication 46 to use for transferring some data to the memory card by wirelessly, a sound system 47 to play a sound track or the sound of video track or a song, an ON/OFF button 48 to switch said smart business card to ON and OFF.

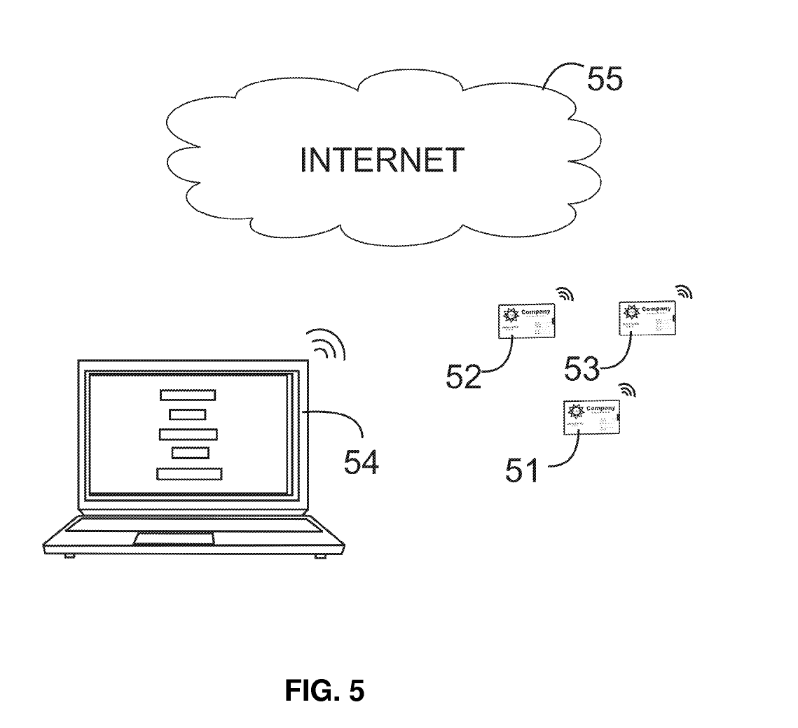

In one embodiment of the present invention as shown in FIG. 5, the smart business card 51, 52, 53 can receive plurality of information from each other's, a computer 54 or the internet 55 to display on the touchscreen device.

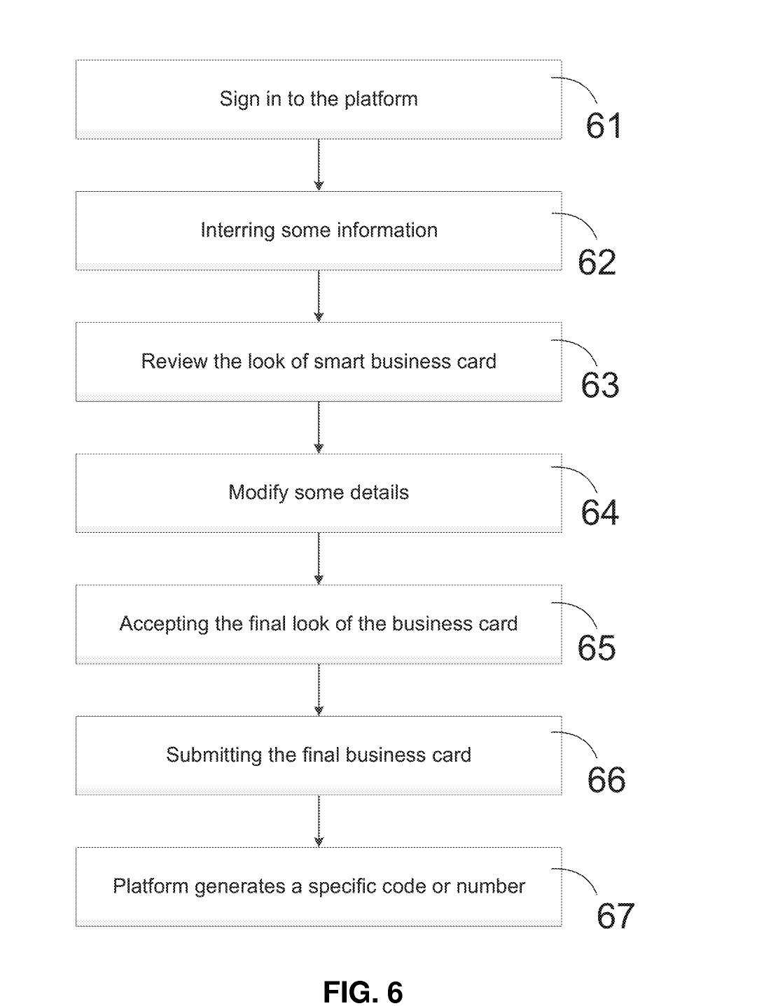

In one embodiment of the present invention as shown in FIG. 6, each individual can sign in to a universal platform 61 which feeds the smart business cards. By signing to said platform through the internet, said individuals can provide their information 62, such as name, telephone number and address, to their accounts, review the look of their business cards 63, modify the details 64, and again review the look after the modification. The individuals can then accept the preferred look of their business card 65, and submit the business card 66 to the data base. The platform generates a specific Number or code 67 for said individuals.

Said specific number or codes are used as an ID for each individual. The individual can give this number or code to their business partners, clients or other interested parties. The receiver of the code or number can input the code and identify the information of said individual through the platform by connecting to the internet.

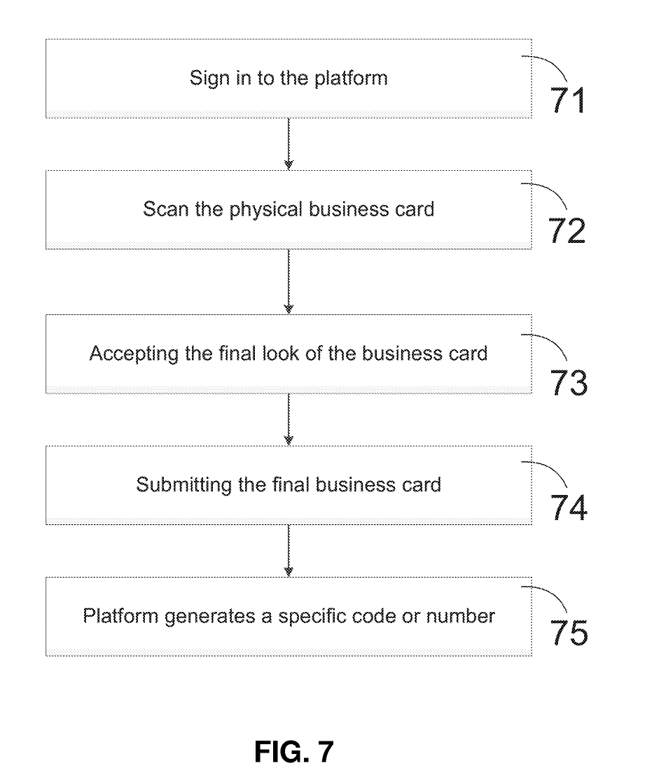

In another embodiment of the present invention, a company website or LinkedIn profiles can use to provide the necessary information for the smart business cards. Another way to provide data for the smart business card as shown in FIG. 7 is to sign in to the platform 71, scan or take a picture of physical business card 72, accept the look of the business card 73, and submit the picture of the business card 74. The platform generates a specific number or code 75 for said individuals.

In another embodiment of the present invention, the smart business card can work online or offline. The business card which works online can connect to the platform through the internet and obtain the new and updated information for each individual. In an offline mode, the smart business card can provide the saved information from its memory card for the user and keep the favorite business cards in the memory cards.

The platform can keep the information of each individual in his/her account as long as they have an active account with a platform. Each individual can change his/her information through the platform and update the information.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A smart business card to display information comprising:
a. a touchscreen having a front side to display a plurality of data;
b. a back side to display name, address and other information about the card holder;
c. a memory card to store said data;
d. a battery management to supply power for said smart business card;
e. a wireless communication means to communicate with the internet, a computer, and another smart business card;
f. a sound system to play a sound track;
g. an ON/OFF button to turn ON and OFF said business card;
h. a processor to manage functionality of said touchscreen, said memory card, said battery, said sound system and said information; and
i. a housing adopted to receive said touchscreen, said memory card, said wireless communication, said sound system, said ON/OFF button and said processor.

2. The smart business card of claim 1, wherein said touchscreen being selected from the group consisting of LED screen, OLED screen, flexible screen, transparent screen, and flexible transparent screen.

3. The smart business card of claim 1, wherein said memory card being selected from the group consisting of a flash card, a SD card, and mini SD card.

4. The smart business card of claim 1, wherein said memory card being permanent and said data being stored in said memory card permanently.

5. The smart business card of claim 1, wherein said back side comprises of a touchscreen to display a plurality of data.

6. The smart business card of claim 1, wherein said memory card being a temporary memory card or a permanent memory card.

7. The smart business card of claim 1, wherein said wireless communication means being connected to the internet server, a plurality of smart business card, and a computer.

8. The smart business card of claim 1, wherein said data to be displayed on the touch screen being personal information of the business card owner, and wherein said information can be changed by a user.

9. A smart business card platform to manage a plurality of data from a plurality of smart business card comprising:
a. a website to collect said data from a plurality of individual and transfer said data to a plurality of smart business card comprising:
i. signing to said website;
j. selecting a specific outline for design a smart business card;
k. interring a plurality of data into said outline;
l. reviewing the smart business card;
m. accepting the look of said smart business card;
n. submitting the smart business card into the website; and
o. generating a specific code or a number, wherein said code or number being used as an ID for each said smart business card.
b. said plurality of smart business card comprising:
i. a touchscreen having a front side to display a plurality of data;
j. a back side to display a logo and a company name permanently;
k. a memory card to store said data;
l. a battery management to supply power for said smart business card;
m. a wireless communication means to communicate with the internet, a computer, and another smart business card;
n. a sound system to play a sound track;
o. an ON/OFF button to turn ON and OFF said business card;
p. a processor to manage functionality of said touchscreen, said memory card, said battery, said sound system and said information; and
q. a housing adopted to receive said touchscreen, said memory card, said wireless communication, said sound system, said ON/OFF button and said processor.

10. The smart business card platform of claim 9, wherein said touchscreen being selected from the group consisting of LED screen, OLED screen, flexible screen, transparent screen, and flexible transparent screen.

11. The smart business card platform of claim 9, wherein said memory card being selected from the group consisting of a flash card, a SD card, and mini SD card.

12. The smart business card platform of claim 9, wherein said memory card being permanent and said data being stored in said memory card permanently.

13. The smart business card platform of claim 9, wherein said back side comprises of a touchscreen to display a plurality of data.

14. The smart business card platform of claim 9, wherein said memory card being a temporary memory card or a permanent memory card.

15. The smart business card platform of claim 9, wherein said wireless communication means being connected to the internet server, a plurality of smart business card, and a computer.

16. The smart business card platform of claim 9, wherein said data to be displayed on the touch screen being personal information of the business card owner, and wherein said information can be changed by a user.
